(19) United States
(12) Patent Application Publication
(10) Pub. No.: US 2011/0109773 A1
(43) Pub. Date: May 12, 2011

(54) SYSTEM AND METHOD FOR ADAPTIVE NONLINEAR COMPRESSED VISUAL SENSING

(75) Inventor: Shai Dekel, Ramat Hasharon (IL)

(73) Assignee: General Electric Company

(21) Appl. No.: 12/615,641

(22) Filed: Nov. 10, 2009

(51) Int. Cl. H04N 5/217; H04N 5/228; H04N 5/225

(52) U.S. Cl. 348/241; 348/222.1; 348/340; 348/E05.031; 348/E05.024; 348/E05.079

(57) ABSTRACT

A novel and useful system and method for adaptive nonlinear compressed visual sensing. The adaptive nonlinear compressed sensing mechanism provides a modified DMD sensing architecture incorporating a nonlinear optical intensifier coupled with a nonlinear acquisition process. The modified DMD sensing architecture and related circuitry and software are operative to perform nonlinear image acquisition by computing both linear and nonlinear functionals. These computations are performed recursively to approximate the image to achieve any desired target image quality.

### FIELD OF THE DISCLOSURE

The subject matter disclosed herein relates to the field of digital imaging, and more particularly relates to a method and system for adaptive nonlinear compressed visual sensing.

### BACKGROUND

Currently, the use of acquisition devices such as charge coupled devices (CCDs) is widespread. A CCD is a device for the movement of electrical charge, usually from within the device to an area where the charge can be manipulated, for example conversion into a digital value. This is achieved by shifting the signals between stages within the device one at a time. CCDs are actually implemented as shift registers that move charge between capacitive bins in the device, with the shift allowing for the transfer of charge between bins.

The CCD is usually integrated with a sensor, such as a photoelectric device to produce the charge that is being read, thus making the CCD a major technology where the conversion of images into a digital signal is required. CCDs are currently widely used in professional, medical, and scientific applications where high-quality image data is required.

As the size of the imaging areas and the accompanying number of pixels of CCDs and other imaging devices grows, however, these devices produce larger and larger datasets. For example, there is large market demand for increased resolution in digital cameras and video camcorders. There are is also an increasing number of applications for multi-sensor architectures, producing even larger signal datasets. The prior art approach to handling these exploding datasets is to apply some form of compression techniques after the acquisition process of the dataset.

### BRIEF DESCRIPTION OF THE DISCLOSURE

There is thus provided a method of compressed sensing of an image, the method comprising first calculating an approximation of a portion of the image, performing at least one nonlinear measurement of the image portion, second calculating an error on the image portion in accordance with the image approximation and the at least one nonlinear measurement, if the error is greater than a threshold, sub-dividing the image portion into a plurality of image portions and recursively repeating first calculating, performing at least one nonlinear measurement, second calculating and dividing until the error is less than or equal to the threshold for all image portions.

There is also provided a method of compressed sensing of an image, the method comprising performing one or more linear measurements on portions of the image, performing one or more nonlinear measurements on the portions of the image and computing an adaptive approximation of the image utilizing the one or more linear measurements and the one or more nonlinear measurements.

There is further provided an apparatus for compressed sensing of an image comprising a micro-mirror array module, an optical intensifier placed before the micro-mirror array module and operative to apply a nonlinear gain to light passing through it to the micro-mirror array module, a controller operative to control the optical intensifier and the micro-mirror array module to reflect portions of the image onto a detector so as to capture both linear and nonlinear measurements and an image generator operative to compute an adaptive approximation to reconstruct the image utilizing the linear and nonlinear measurements from the detector.

There is also provided computer program product characterized by that upon loading it into computer memory a process of compressed sensing of an image is executed, the computer program product comprising a computer usable medium having computer usable program code embodied therewith, the computer usable program code comprising computer usable code configured to control an optical intensifier placed before a micro-mirror array module and operative to apply nonlinear gain to light passing through it, computer usable code configured to control the micro-mirror array module to reflect portions of the image onto a detector so as to capture both linear and nonlinear measurements and computer usable code configured to compute an adaptive approximation to reconstruct the image utilizing the linear and nonlinear measurements from the detector.

### BRIEF DESCRIPTION OF THE DRAWINGS

The invention is herein described, by way of example only, with reference to the accompanying drawings, wherein:

FIG. 1 is a block diagram illustrating an example computer processing system for implementing the adaptive nonlinear compressed sensing mechanism of the present invention;

FIG. 2 is an example CCD imaging sensor in a digital camera;

FIG. 3A is a sparse wavelet representation of an image;

FIG. 3B is a JPEG2000 compressed image based on the sparse representation of FIG. 3A;

FIG. 4 is a diagram illustrating an example DMD based adaptive nonlinear compressed sensing system;

FIG. 5 is a flow diagram illustrating an example method of adaptive nonlinear compressed sensing;

FIG. 6 is a block diagram illustrating the data flow of an example adaptive nonlinear compressed sensing system;

FIGS. 7A, 7B, 7C are diagrams illustrating several example image portions to be measured during execution of the method of FIG. 6; and

FIG. 8 is a diagram illustrating example active and inactive node image portions during execution of the method of FIG. 6.

### DETAILED DESCRIPTION OF THE DISCLOSURE

### Notation Used Throughout

The following notation is used throughout this document:

| Term | Definition |
|---|---|
| ADC | Analog to Digital Converter |
| ASIC | Application Specific Integrated Circuit |
| CCD | Charge Coupled Device |
| CDROM | Compact Disc Read Only Memory |
| CMOS | Complimentary Metal Oxide Semiconductor |
| CPU | Central Processing Unit |
| CS | Compressed Sensing |
| DCT | Discrete Cosine Transform |
| DMD | Digital Micro-Mirror Device |
| DSP | Digital Signal Processor |
| DWT | Discrete Wavelet Transform |
| EPROM | Erasable Programmable Read-Only Memory |
| FIR | Finite Impulse Response |
| FPGA | Field Programmable Gate Array |
| FTP | File Transfer Protocol |
| HTTP | Hyper-Text Transport Protocol |
| JPEG | Joint Photographic Experts Group |
| LAN | Local Area Network |
| NIC | Network Interface Card |
| RAM | Random Access Memory |
| RF | Radio Frequency |
| ROM | Read Only Memory |
| SAN | Storage Area Network |
| SRAM | Static Random Access Memory |
| TLIT | Toggled Light Intensifier Tube |
| WAN | Wide Area Network |
| WWAN | Wireless Wide Area Network |

### DETAILED DESCRIPTION

A novel and useful system and method for adaptive nonlinear compressed visual sensing is described. The adaptive nonlinear compressed sensing mechanism provides a modified DMD sensing architecture incorporating a nonlinear optical intensifier coupled with a nonlinear acquisition process. The modified DMD sensing architecture and related circuitry and software are operative to perform nonlinear image acquisition by computing both linear and nonlinear functionals. These computations are performed recursively to approximate the image to achieve any desired target image quality.

The adaptive nonlinear compressed sensing mechanism enables the acquisition and compression of high resolution visual data, without the need to fully sample the entire dataset at its highest resolution, using significantly less measurements. The compressed sensing techniques described herein replaces the prior art methodology of random measurements and computationally intensive reconstruction with a direct and fast adaptive approximation method combining linear and nonlinear measurements.

### Computer Processing System

As will be appreciated by one skilled in the art, the present invention may be embodied as a system, method, computer program product or any combination thereof. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

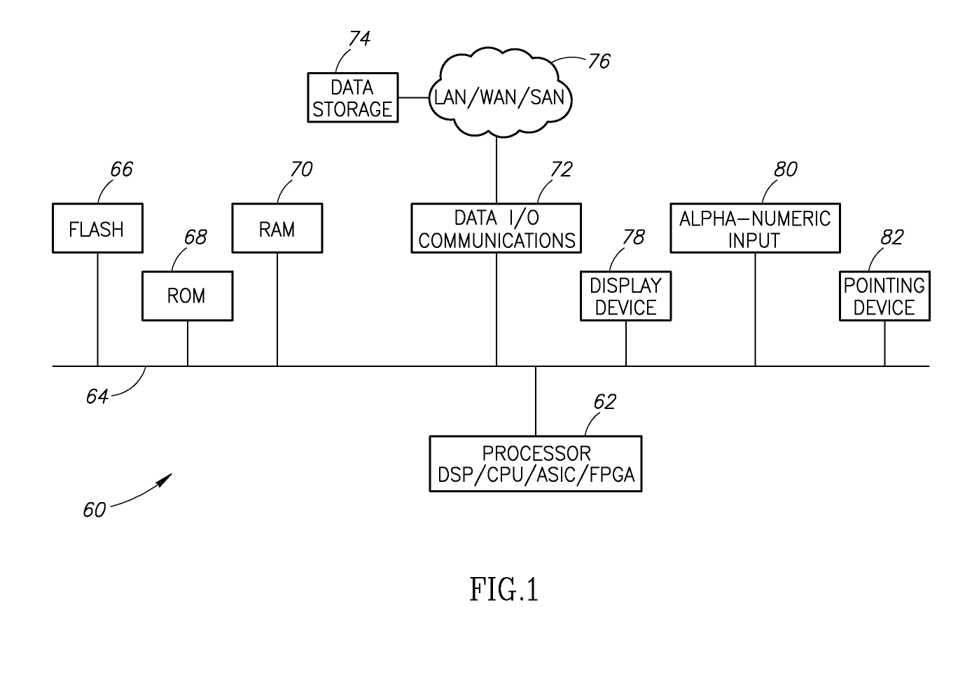

A block diagram illustrating an example computer processing system for implementing the adaptive nonlinear compressed sensing mechanism of the present invention is shown in FIG. 1. The computer system, generally referenced 60, comprises a processor 62 which may comprise a digital signal processor (DSP), central processing unit (CPU), microcontroller, microprocessor, microcomputer, ASIC or FPGA core. The system also comprises static read only memory 68 and dynamic main memory 70 all in communication with the processor. The processor is also in communication, via bus 64, with a number of peripheral devices that are also included in the computer system. Peripheral devices coupled to the bus include a display device 78 (e.g., monitor), alpha-numeric input device 80 (e.g., keyboard) and pointing device 82 (e.g., mouse, tablet, etc.)

The computer system is connected to one or more external networks such as a LAN/WAN/SAN 76 via communication lines connected to the system via data I/O communications interface 72 (e.g., network interface card or NIC). The network adapters 72 coupled to the system enable the data processing system to become coupled to other data processing systems or remote printers or storage devices through intervening private or public networks. Modems, cable modem and Ethernet cards are just a few of the currently available types of network adapters. The system also comprises magnetic or semiconductor based storage device 74 for storing application programs and data. The system comprises computer readable storage medium that may include any suitable memory means, including but not limited to, magnetic storage, optical storage, semiconductor volatile or non-volatile memory, biological memory devices, or any other memory storage device.

Software adapted to implement the adaptive nonlinear compressed sensing mechanism of the present invention is adapted to reside on a computer readable medium, such as a magnetic disk within a disk drive unit. Alternatively, the computer readable medium may comprise a floppy disk, removable hard disk, flash memory 66, EEROM based memory, bubble memory storage, ROM storage, distribution media, intermediate storage media, execution memory of a computer, and any other medium or device capable of storing for later reading by a computer a computer program implementing the mechanism of this invention. The software adapted to implement the adaptive nonlinear compressed sensing mechanism of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the adaptive nonlinear compressed sensing mechanism of the present invention, and to the extent that a particular system configuration is capable of implementing the system and methods of this invention, it is equivalent to the representative digital computer system of FIG. 1 and within the spirit and scope of this invention.

Once they are programmed to perform particular functions pursuant to instructions from program software that implements the system and methods of this invention, such digital computer systems in effect become special purpose computers particular to the mechanism of this invention. The techniques necessary for this are well-known to those skilled in the art of computer systems.

It is noted that computer programs implementing the system and methods of this invention will commonly be distributed to users on a distribution medium such as floppy disk or CDROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or by combinations of special purpose hardware and computer instructions.

### First Embodiment

### Linear Compressed Visual Sensing

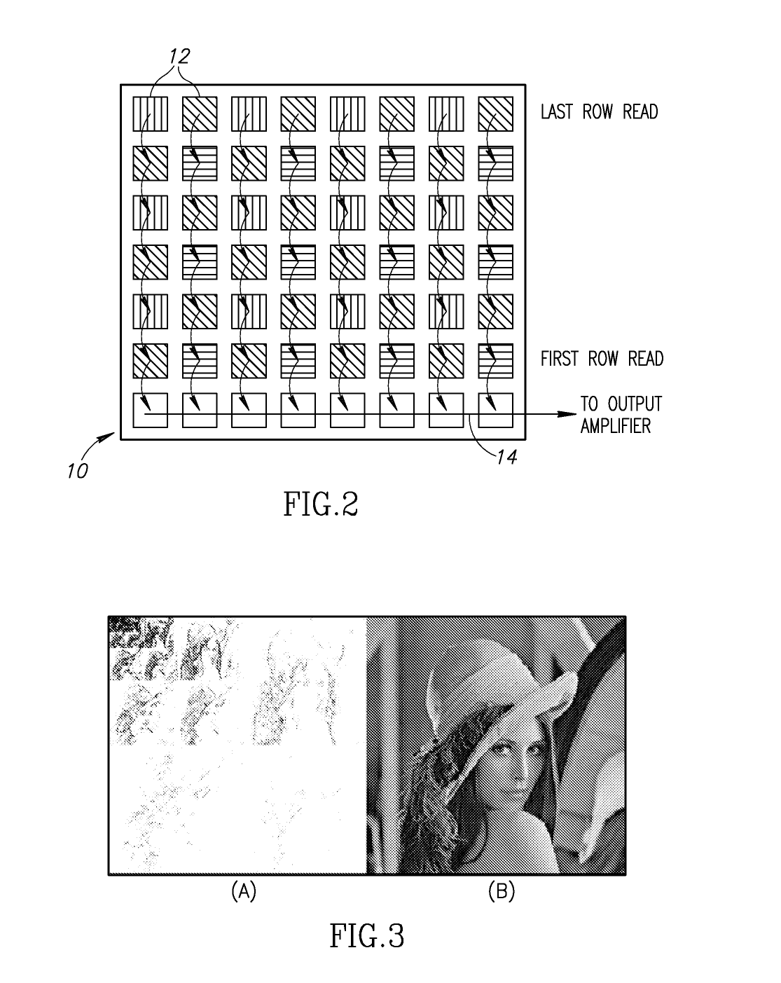

Consider a digital camera as an example imaging device incorporating a CCD imaging chip. An example CCD imaging sensor as found in a typical digital camera is shown in FIG. 2. The CCD, generally referenced 10, comprises a photoactive region containing a grid of pixels 12. Assume x is a digital image consisting of N pixels that are to be acquired. Some digital cameras perform the image acquisition using an array of N CCDs. The electrical charge generated on each pixel by exposure of the CCD to light is coupled or transferred using appropriate clocking signals from row to row until read out (i.e. shifted out) and fed to an output amplifier at the last row (14). They then undergo a conversion from analog to digital. Another technology known as Complementary Metal Oxide Semiconductor (CMOS) allows high end digital cameras to acquire approximately 12 million pixels (3000×4000).

Once the digital image x has been acquired, it is usually then compressed. In most digital cameras the user has the capability to control the compression/quality tradeoff, through the camera settings. Standard compression algorithms such JPEG and JPEG2000 are commonly used to compress the image. These compression algorithms are both ‘transform-based’ and operate as follows.

First, a transform is applied to the image Tx=c to yield N coefficients. Note that in the case of JPEG2000, a wavelet transform is applied. In the case of JPEG, a local discrete cosine transform (DCT) is applied. Exactly N coefficients are obtained for ‘critically-sampled’ transforms. More than N coefficients may be obtained for redundant transforms when using frames.

A quantization process is then applied to the transform coefficients c such that a sparse representation remains consisting of approximations of only k of the coefficients, with k<<N (k significantly smaller than N, in a relative sense).

Then entropy coding is applied to the quantized coefficients, thereby generating a compressed bit-stream. Typically, the compression ratio, i.e. the ratio between the size of the compressed image and the size of the image, is k/N for grayscale images.

A sparse wavelet representation of the image Lena is shown in FIG. 3A. A compressed version of this image, where the compression algorithm was based on the sparse representation, is shown in FIG. 3B. It is noted how the significant wavelet coefficients, i.e. the coefficients with the relatively large absolute value, are located on strong edges of the image.

Many acquisition devices commonly in use today generate very large datasets. These datasets are immediately reduced using signal processing techniques to a smaller dataset. A signal acquisition paradigm, known as Compressed Sensing (CS), attempts to improve this process by providing mathematical tools that, when coupled with specific acquisition hardware architectures, can potentially reduce the acquired dataset sizes, without reducing the resolution or quality of the compressed signal. A brief mathematical framework of compressed sensing is provided below.

First acquire n<<N measurements, using a sampling matrix Φ, by computing for a signal x

$$\underbrace{Φ}_{n \times N} \underbrace{x}_{N \times 1} = \underbrace{y}_{n \times 1} \qquad ( 1 )$$

Since n, the dimension of y (i.e. the vector of acquired samples), is substantially smaller than N, the dimension of the signal, we obtain some initial compression, which can be further augmented by applying lossy or lossless compression to the vector y.

Similarly to standard transform-based compression techniques, the paradigm of compressed sensing is based on the assumption that the signal x has a sparse representation in some basis such as wavelets. This means that we assume that there exists a known fixed transform T, such that from the N (or more) transform coefficients c=Tx, only k<n coefficients are significant. Working under this ‘sparsity’ assumption an approximation to x can be reconstructed from y by ‘sparsity’ minimization, such as l₁ minimization

$${min}_{Φ {T}^{- 1} c = y} {‖ c ‖}_{{l}_{1}} \qquad ( 2 )$$

Under certain conditions exact reconstruction of x is possible, i.e. when a vector of dimension N can be exactly recovered by the minimization process (Equation 2) from the smaller number of n measurements. Compressed sensing techniques can indicate when exact reconstruction is possible with very high probability or when the solution to the minimization problem (Equation 2) provides a good approximation to the real solution. A key assumption is that the sampling process determined by the matrix Φ and the sparsity transform T are ‘incoherent,’ meaning that if a signal has a sparse representation in one, then it must have a dense representation in the other and visa versa, but a signal cannot have a sparse representation in both.

An example application of compressed sensing within the framework of a ‘single pixel’ digital camera architecture will now be described. The compressed sensing camera replaces the CCD and CMOS acquisition technologies by a Digital Micro-mirror Device (DMD). The DMD consists of an array of electrostatically actuated micro-mirrors where each mirror of the array is suspended above an individual SRAM cell. Each mirror rotates about a hinge and can be positioned in one of two states: +12 degrees or −12 degrees from horizontal. Using lenses, all the reflections from the micro-mirrors at a given state, say +12 degrees for example, are focused onto and collected by a single photodiode to yield an absolute voltage. The output of the photodiode is amplified through an amplifier circuit (e.g., op-amp circuit) and then digitized by an analog-to-digital converter (e.g., 12-bit). The output v of the ADC can be interpreted as follows

$$v = {\sum }_{i = 1}^{N} {x}_{i} {1}_{{θ}_{i} = + 12} + DC offset \qquad ( 3 )$$

where

x=(x₁, . . . , x_{N}) is a input digital image;

1_{θ}_{ₜ}₌₊₁₂ is an indicator function that is set to the value 1 if the i^{th} micro-mirror is at the state +12 degrees and 0 otherwise;

the DC offset is the value output when all the micro-mirrors are set to −12 degrees;

It is noted that current DMD hardware platforms are capable of performing tens of thousands configured samples a second. The resolution of current DMD hardware platforms is currently approximately 11 Mega pixels.

In one embodiment, the rows of the compressed sampling matrix Φ comprise a sequence of n pseudo-random binary masks, where each mask is a ‘scrambled’ configuration of the DMD array. Thus, the measurement vector y is composed of dot-products of the digital image x with pseudo-random masks. The measurements taken are collected into a compressed bitstream with possible lossy or lossless compression applied to the elements of y. During the decoding process, which takes place at the viewing device, a minimization algorithm solves Equation 2. An approximate ‘reconstructed’ image is obtained by applying the transform T⁻¹ to the coefficients of the computed solution to Equation 2. In one example, the transform T is chosen to be a wavelet transform, but using compressed sensing, any transform T which is in incoherence with a process of pseudo-random masks Φ (almost all reasonable transforms have this property) and in which the image has a sparse representation will yield an image reconstruction with good approximation to the original image.

One disadvantage of the first embodiment compressed sensing technique is that it exhibits poor control over the quality of the output compressed image. From the theory of wavelet approximation, the error of an n-term wavelet approximation is determined by the ‘weak-type smoothness’ of the image as a function in a Besov space. In other words, the more visual activity in the image, edges and texture parts, the higher the number of wavelet coefficient terms needed to achieve a specified level of visual quality. This compressed sensing architecture, however, is not adaptive and the number of measurements is determined before the acquisition process begins, with no feedback on the progressive quality during the acquisition process.

A second disadvantage is that the compressed sensing technique includes a computationally intensive reconstruction algorithm. It is known that all the algorithms for the l₁-minimization (Equation 2) are very computationally intensive. Therefore, the client application performing the decoding of the compressed sensing bitstream for viewing purposes, analysis or conversion purposes must have sufficient computation resources, especially for the case of an image sequence or video stream.

A third disadvantage is that the compressed sensing technique described supra considers only linear measurements as in Equation 1 which is within the capabilities of existing DMD architectures and is not capable of nonlinear sampling.

### Second Embodiment

### Adaptive Nonlinear Compressed Visual Sensing

In this second embodiment, an adaptive nonlinear compressed visual sensing mechanism is described. The adaptive nonlinear compressed sensing mechanism provides a DMD sensing architecture modified to include a nonlinear optical intensifier placed before the DMD array to generate nonlinear samples.

The DMD architecture enables several embodiments of nonlinear sampling to generate the compressed image. A complimentary decoding process is used to reconstruct the compressed image is no more computational intensive than existing algorithms in use today such as JPEG or JPEG2000 decoding.

The adaptive nonlinear compressed sensing mechanism is a direct and adaptive approach to compressed sensing. The DMD array architecture is used differently than in the first embodiment as described infra. The particular DMD used, however, is not critical to the invention as one skilled in the art can adapt a particular DMD array to a particular implementation of the invention. In one example embodiment, a grayscale DMD array is used. Other DMDs commercially available today allow individual ‘gain’ filters to be applied to the light coming into each the of micro-mirrors. This is achieved by variable flipping of each individual micro-mirror at the time of the acquisition, where no flipping allows all the light coming in to be reflected and faster flipping corresponds to multiplying the value of light coming into the micro-mirror by a smaller coefficient.

These DMD array devices can be used for computation of arbitrary linear functionals, where the computation of requires only two measurements. This is because any real linear functional F: [symbol] ^{N}→ [symbol] ,F(x)= [symbol] V,x [symbol] with V ε [symbol] ^{N}, has the representation F=F₊−F₋ where F₊(x)= [symbol] V₊,x [symbol] F₋(x)= [symbol] V₋,x [symbol] where V₊,V₋ are vectors in [symbol] ^{N} with positive coefficients.

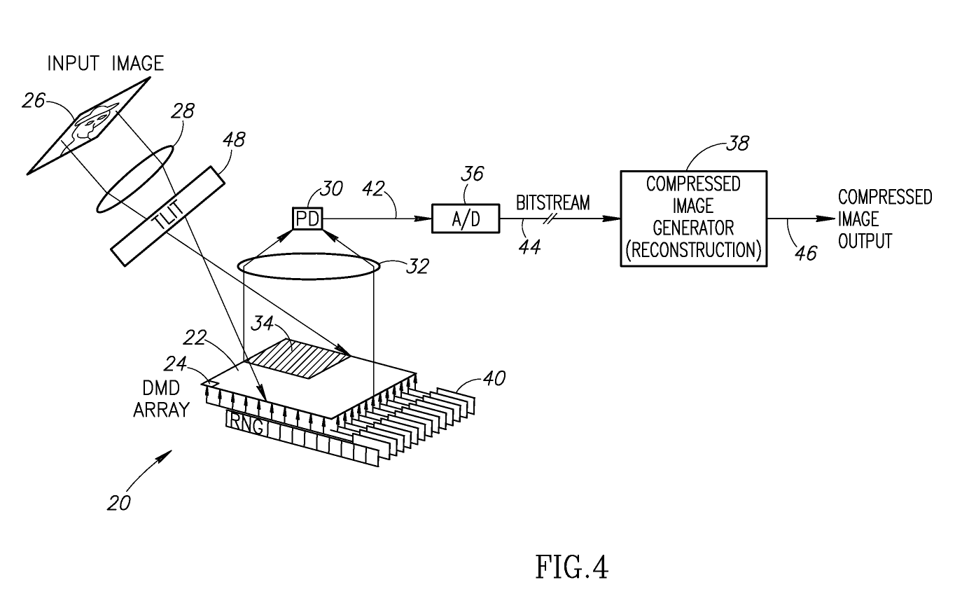

In this second embodiment, the architecture of a DMD is modified to permit nonlinear acquisition of the input image. A diagram illustrating an example DMD based adaptive nonlinear compressed sensing system is shown in FIG. 4. The adaptive nonlinear compressed sensing system, generally referenced 20, comprises a DMD array 22 having a plurality of individual micro-mirrors 24, DMD control circuitry 40, lenses 28 and 32 for focusing light from an input image 26 onto a detector 30 (e.g., photodiode). The voltage output 42 of the detector is converted from the analog to the digital domain by ADC 36 and the resulting bitstream 44 is input to a compressed image generator/reconstruction module 38 which generates the output compressed image 46.

A light intensifier 48 such as a toggled light intensifier tube (TLIT) that is capable of applying a nonlinear function to light passing through it is placed between focusing lens 28 and the DMD array 22 in the path of the input image that is projected onto the DMD array. This enables the system to perform nonlinear acquisition of the input image.

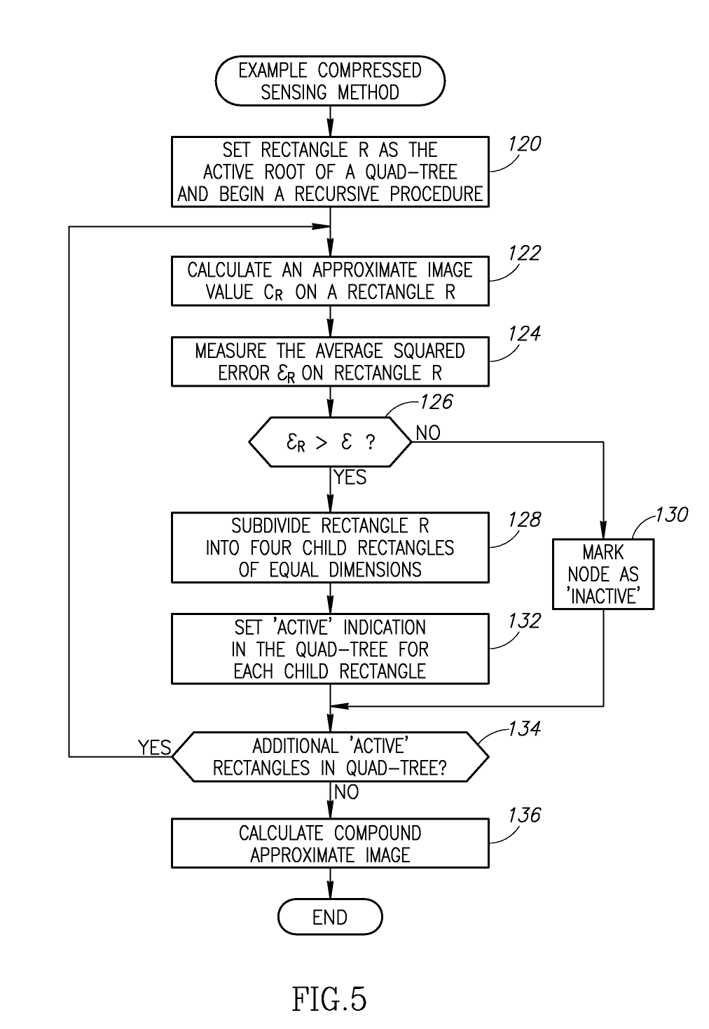

A flow diagram illustrating an example method of adaptive nonlinear compressed sensing is shown in FIG. 5. The compressed sensing method comprises an adaptive approximation algorithm that performs adaptive direct acquisition of a piecewise constant approximation to a given input image. Let f represent an image with values f (i,j), 1≦i≦Width(f), 1≦j≦Height(f). The adaptive piecewise constant approximation algorithm is based on a quad-tree scheme as described below. The quad-tree can have active and inactive nodes.

The rectangle R having dimensions [1, Width (f)]×[1, Height (f)] is set as the ‘active’ root of a quad-tree and a recursive procedure is begun (step 120). Initially, the rectangle is set to the entire image. For each ‘active’ node in the quad-tree perform the following two steps. First, calculate an approximation to the image in the rectangle R associated with the node as a constant c_{R} (step 122). This is computed by averaging as expressed below

$${c}_{R} := \frac{1}{\# \{ ( i , j ) ∈ R \}} {\sum }_{( i , j ) ∈ R} f ( i , j ) \qquad ( 4 )$$

Where #{(i,j)εR} is the number of pixels in the rectangle R and f (i,j) are the actual pixels values of the image. Note that in this step, the DMD array is configured to turn on all mirrors corresponding to the pixels in the rectangle of the image. In addition, the light intensifier is off or set to a zero or linear gain.

Second, measure the averaged squared error ε_{R} on rectangle R using the following (step 124).

$${ɛ}_{R} = \frac{1}{\# \{ ( i , j ) ∈ R \}} {\sum }_{( i , j ) ∈ R} {( f ( i , j ) - {c}_{R} )}^{2} \qquad ( 5 )$$

Where c_{R} is the image approximation calculated in Equation 4. If ε_{R} is greater than some predetermined average error ε (step 126), then subdivide the rectangle R into four child rectangles of equal dimensions (step 128). For each child rectangle create an ‘active’ child node in the quad-tree (step 132) and the method repeats recursively for each child node. If ε_{R}≦ε (step 126), then the node is marked as ‘inactive’ (step 130).

As long as there are additional ‘active’ rectangles in the quad-tree (step 134), the method continues recursively with step 122 and an image approximation and average squared error for each child rectangle node is calculated. Once all ‘active’ nodes have been processed (i.e. no active nodes remain and there are only inactive nodes), the approximating piecewise constant approximation to the image is calculated as

$$S ( i , j ) = {\sum }_{R leaf in quad \text{-} tree} {c}_{R} {χ}_{R} ( i , j ) \qquad ( 6 )$$

where S(i, j) represents the compound approximate image (i.e. the compressed image) (step 136).

$${χ}_{R} ( i , j ) := \{ \begin{matrix}1 & ( i , j ) ∈ R , \\ 0 & ( i , j ) ∉ R .\end{matrix} \qquad ( 7 )$$

It is noted that using current DMD architectures, it is possible to compute Equation 4 for any portion of the image since it can be realized as a linear functional. Note also that the approximation technique described supra is not limited to dividing the image into rectangles, as the image can be divided in any desired manner. The shape and contour of the image portion, i.e. rectangles, etc., is not critical as long as the micro-mirrors situated at the locations (i,j)εR (i.e. pixels in the rectangle or other contour) are turned ‘on’ and reflect light into the photodiode. The measurement taken at the photodiode computes the value

$${\sum }_{( i , j ) ∈ R} f ( i , j )$$

in a single measurement. The averaging of this sum can be performed in a later stage after the analog to digital conversion. In one example embodiment, a modified DMD architecture stores the quantities #{(i,j)εR} in memory for each possible rectangle R in the quad-tree. Thus, there is no additional computational cost for the averaging computation.

The expression for the average squared error ε_{R} on rectangle R in Equation 5, however, is a nonlinear functional which cannot be computed by a conventional DMD. To enable computation of nonlinear functionals, a nonlinear optical element 48 (FIG. 4) such as a Toggled Light Intensifier Tube (TLIT) is inserted between the outer focusing lens and the DMD array as shown in FIG. 4.

Preferably, the nonlinear optical element (e.g., TLIT) has the following properties. First, it should be possible to either remove or switch off the light intensifier before each sample (to acquire linear measurements). Alternatively, it should be possible to adaptively set the gain of the light intensifier to zero linear gain before each measurement, so that light coming out of the intensifier is the same light that enters.

Second, it should be possible to set the gain of the intensifier to one or more nonlinear gain settings. In one embodiment the TLIT applies a squared gain on light coming through it such that each micro-mirror element (i,j) receives the light f (i.j)² when the intensifier is turned on and f (i.j) when it is turned off. The light intensifier, however, may be adapted to apply other nonlinear functions to the light passing through it, depending on the particular implementation and light intensifier used. For example, in some embodiments the TLIT is configured to apply nonlinear gains functions other than the quadratic such as f (i,j)³, f(i,j)⁴, e^{f(i,j)}, etc.

Note that with the addition of the light intensifier (e.g., TLIT) component 48 the nonlinear functional (Equation 5) can be computed with a single measurement and two additional digital computations in the controller unit. This is achieved by decomposing Equation 5 to the following single nonlinear measurement and two digital computations:

$${ɛ}_{R} = \underbrace{\frac{1}{\# \{ ( i , j ) ∈ R \}} \times \underbrace{( {\sum }_{( i , j ) ∈ R} {f ( i , j )}^{2} )}_{Nonlinear measurement} - {c}_{R}^{2}}_{digital computation} . \qquad ( 8 )$$

Thus, the average squared error ε_{R} can be computed by (1) a table lookup for the number # of pixels in the rectangle, (2) a nonlinear measurement using the light intensifier for the summation of the image pixel values squared, and (3) a linear measurement (i.e. light intensifier set to zero linear gain) for the image approximation.

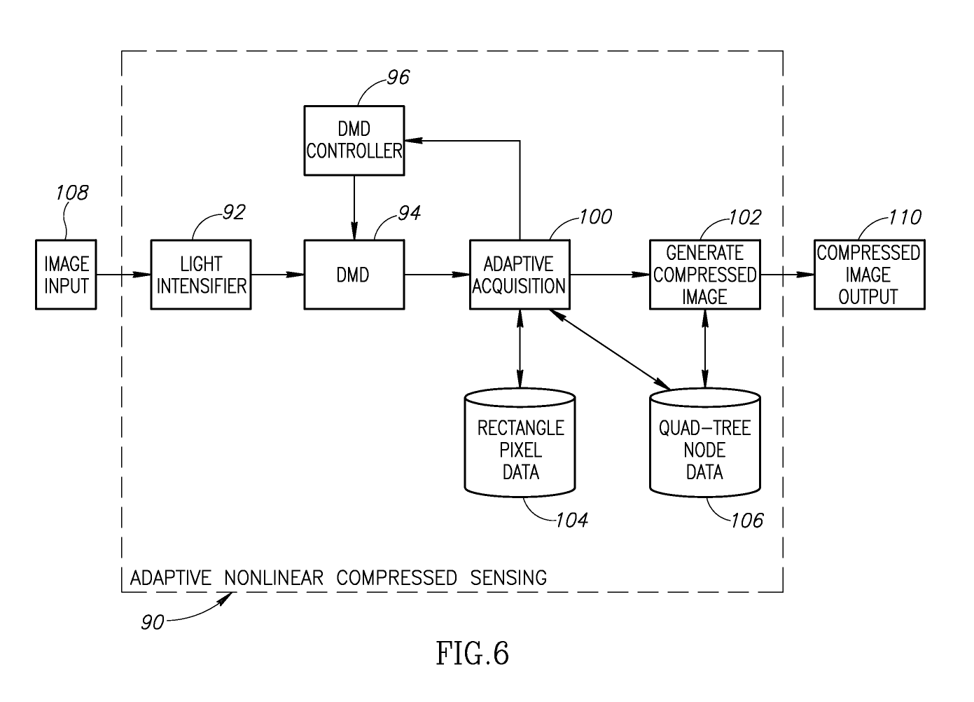

A block diagram illustrating the data flow of an example adaptive nonlinear compressed sensing system is shown in FIG. 6. The adaptive nonlinear compressed sensing system, generally referenced 90, comprises a DMD array 94, light intensifier 92 placed between the input image and the DMD array, DMD controller 96, adaptive acquisition module 100, compressed image generator module 102, rectangle pixel database or look up table 104 and a quad-tree node database for storing active and inactive node information. The light intensifier can be configured to zero linear gain and one or more nonlinear gain settings.

In operation, the adaptive acquisition module controls the image acquisition process. Linear measurements of the input image 108 (or a portion thereof) are made with the light intensifier configured to zero linear gain (or switched off). The DMD controller configures the DMD 94 to reflect only those pixels in the particular rectangle to be measured. The linear measurement computes the image approximation (Equation 4). Information regarding the number # of pixels in the rectangle (or current image portion) stored in the rectangle pixel database 104 is retrieved to complete the computation.

The nonlinear measurement portion of Equation 8 (average squared error) is performed with the light intensifier set to a nonlinear gain (e.g., squared). The nonlinear measurement is then used to compute Equation 8 for each active node.

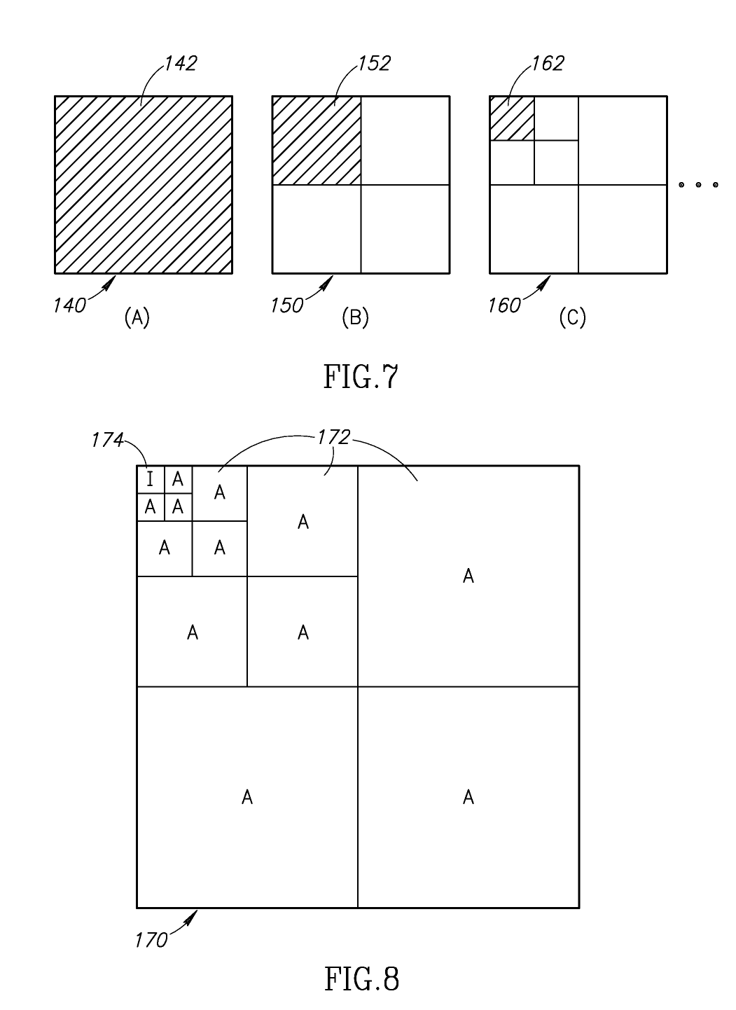

To illustrate the compressed sensing mechanism, consider the initial iteration of the method of FIG. 5. In the first iteration, the rectangle 142 comprises the entire image 140, as shown in FIG. 7A. Assuming the average squared error is larger than the threshold, the rectangle is sub-divided into four rectangles of equal dimension as shown in FIG. 7B, and all are set to ‘active’ node status and placed in the quad-tree. The method proceeds in a second iteration with the upper left rectangle 152 portion of the image 150. Assuming the average squared error here too is larger than the threshold, the rectangle 152 is sub-divided into four rectangles of equal dimension as shown in FIG. 7C, and all are set to ‘active’ node status and placed in the quad-tree. The method proceeds in a third iteration with the upper left rectangle 162 portion of the image 160. In this manner the entire image is approximated recursively until the threshold criteria is met for all nodes. A diagram illustrating example active and inactive node image portions during execution of the method of FIG. 6 is shown in FIG. 8. In this example, the image 170 has undergone several iterations and most rectangles 172 are set to ‘active’ A. One rectangle 174 is set to inactive since its average squared error is less than or equal the threshold error.

In alternative embodiments, the compressed sensing techniques described supra can be used to implement higher order approximation schemes as well. Assuming one wants to apply piecewise linear approximation. Then the step of calculating the average squared error (step 124, FIG. 5, Equation 5) in the recursive quad-tree algorithm described supra is replaced by the following steps.

First, the coefficients a,b,c ε [symbol] are found such that

$$( a , b , c ) = arg min \{ {\sum }_{( i , j ) ∈ R} {( f ( i , j ) - ( a i + b j + c ) )}^{2} \} \qquad ( 9 )$$

It is noted that these coefficients represent a planar equation, i.e. the pixel data of the rectangle is approximated by an ‘optimal planar piece’. This provides a better approximation than an average, since approximating by a plane is better than approximating with a constant (the constant function is a special case of a plane parallel to the x-y plane).

Equation 8 can be solved using the linear system

$$( \begin{matrix}{\sum }_{( i , j ) ∈ R} {i}^{2} & {\sum }_{( i , j ) ∈ R} i j & {\sum }_{( i , j ) ∈ R} i \\ {\sum }_{( i , j ) ∈ R} i j & {\sum }_{( i , j ) ∈ R} {j}^{2} & {\sum }_{( i , j ) ∈ R} j \\ {\sum }_{( i , j ) ∈ R} i & {\sum }_{( i , j ) ∈ R} j & \# \{ ( i , j ) ∈ R \}\end{matrix} ) ( \begin{matrix}a \\ b \\ c\end{matrix} ) = ( \begin{matrix}{\sum }_{( i , j ) ∈ R} i f ( i , j ) \\ {\sum }_{( i , j ) ∈ R} j f ( i , j ) \\ {\sum }_{( i , j ) ∈ R} f ( i , j )\end{matrix} ) . \qquad ( 10 )$$

Therefore, to obtain the right hand side of the linear system of Equation 10 one needs to evaluate three linear functionals that are obtained with three linear measurements of the DMD array (i.e. light intensifier is off or set to zero gain) since they are positive functional. Once the system is solved the error can be evaluated as follows

$${ɛ}_{R} = \frac{1}{\# \{ ( i , j ) ∈ R \}} {\sum }_{( i , j ) ∈ R} {( f ( i , j ) - ( a i + b j + c ) )}^{2} , \qquad ( 11 )$$

Once the error is computed, it is tested against the required tolerance averaged squared error ε. This requires a single nonlinear measurement and several linear measurements which can be implemented using the DMD image acquisition system of FIG. 4.

In alternative embodiments, higher order approximation schemes can be used (e.g., quadratic, cubic, etc.). Any such higher order scheme can be implemented by solving a linear system of moments of the type in Equation 10 above to compute the optimal local polynomial approximation, followed by an error computation of the type in Equation 11 which requires one nonlinear measurement and several additional linear measurements.

In alternative embodiments, the adaptive nonlinear compressed sensing mechanism is used to acquire and compress sequences of 2D images or video streams, where each 2D frame of the sequence or video stream is acquired using the techniques and methods described supra.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of one or more embodiments of the invention. The embodiments were chosen and described in order to best explain the principles and the practical application, and to enable others of ordinary skill in the art to understand the one or more embodiments of the invention for various embodiments with various modifications as are suited to the particular use contemplated.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of compressed sensing of an image, said method comprising:
first calculating an approximation of a portion of said image;
performing at least one nonlinear measurement of said image portion;
second calculating an error on said image portion in accordance with said image approximation and said at least one nonlinear measurement;
if said error is greater than a threshold, sub-dividing said image portion into a plurality of image portions; and
recursively repeating first calculating, performing at least one nonlinear measurement, second calculating and dividing until said error is less than or equal to said threshold for all image portions.

2. The method according to claim 1, wherein first calculating an approximation of a portion of said image is based on at least one linear measurement of said image portion.

3. The method according to claim 1, wherein said at least one nonlinear measurement is made using a optical device having a nonlinear gain placed before a micro-mirror array module configured to reflect only said image portion onto a detector.

4. The method according to claim 3, wherein said nonlinear gain comprises a squared gain.

5. A method of compressed sensing of an image, said method comprising:
performing one or more linear measurements on portions of said image;
performing one or more nonlinear measurements on said portions of said image; and
computing an adaptive approximation of said image utilizing said one or more linear measurements and said one or more nonlinear measurements.

6. The method according to claim 5, wherein said one or more nonlinear measurements are made using a optical device placed having a nonlinear gain before a micro-mirror array module configured to reflect only said image portion onto a detector.

7. The method according to claim 6, wherein said nonlinear gain comprises a squared gain.

8. The method according to claim 5, wherein computing an adaptive approximation comprises computing one or more linear functionals using said one or more linear measurements and one or more nonlinear functionals using said one or more nonlinear measurements.

9. The method according to claim 5, wherein computing an adaptive approximation comprises:
solving a linear system of moments to obtain an optimal local polynomial approximation;
computing an error function based on said polynomial approximation; and
iteratively solving a linear system of moments and computing an error function until said error function is less than a predetermined threshold.

10. The method according to claim 5, further comprising computing an adaptive approximation of a sequence of images that are part of a video stream.

11. An apparatus for compressed sensing of an image, comprising:
a micro-mirror array module;
an optical intensifier placed before said micro-mirror array module and operative to apply a nonlinear gain to light passing through it to said micro-mirror array module;
a controller operative to control said optical intensifier and said micro-mirror array module to reflect portions of said image onto a detector so as to capture both linear and nonlinear measurements; and
an image generator operative to compute an adaptive approximation to reconstruct said image utilizing said linear and nonlinear measurements from said detector.

12. The apparatus according to claim 11, wherein said micro-mirror array module, comprises:
a mirror array having a plurality of mirrors, each mirror configurable to reflect a corresponding portion of said image onto said detector;
a first lens to project said image onto said optical intensifier, wherein light output of said optical intensifier is projected into said mirror array; and
a second lens to project the reflections of said mirror array onto said detector.

13. The apparatus according to claim 11, wherein said nonlinear gain comprises a squared gain.

14. The apparatus according to claim 11, wherein said image generator computes said adaptive approximation by:
first calculating an approximation of a portion of said image;
performing at least one nonlinear measurement of said image portion;
second calculating an error on said image portion in accordance with said image approximation and said at least one nonlinear measurement;
if said error is greater than a threshold, sub-dividing said image portion into a plurality of image portions; and
recursively repeating first calculating, performing at least one nonlinear measurement, second calculating and dividing until said error is less than or equal to said threshold for all image portions.

15. The apparatus according to claim 11, wherein said image generator computes an adaptive approximation by:
solving a linear system of moments to obtain an optimal local polynomial approximation;
computing an error function based on said polynomial approximation; and
iteratively solving a linear system of moments and computing an error function until said error function is less than a predetermined threshold.

16. A computer program product characterized by that upon loading it into computer memory a process of compressed sensing of an image is executed, the computer program product comprising:
a computer usable medium having computer usable program code embodied therewith, the computer usable program code comprising:
computer usable code configured to control an optical intensifier placed before a micro-mirror array module and operative to apply nonlinear gain to light passing through it;
computer usable code configured to control said micro-mirror array module to reflect portions of said image onto a detector so as to capture both linear and nonlinear measurements; and
computer usable code configured to compute an adaptive approximation to reconstruct said image utilizing said linear and nonlinear measurements from said detector.

17. The computer program product according to claim 16, wherein said nonlinear gain comprises a squared gain.

18. The computer program product according to claim 16, wherein said computer usable code configured to compute an adaptive approximation comprises:
computer usable code configured to first calculate an approximation of a portion of said image;
computer usable code configured to perform at least one nonlinear measurement of said image portion;
computer usable code configured to second calculate an error on said image portion in accordance with said image approximation and said at least one nonlinear measurement;
computer usable code configured to sub-divide said image portion into a plurality of image portions, if said error is greater than a threshold; and
computer usable code configured to recursively repeat first calculate, perform at least one nonlinear measurement, second calculate and divide until said error is less than or equal to said threshold for all image portions.

19. The computer program product according to claim 16, wherein said computer usable code configured to compute an adaptive approximation comprises:
computer usable code configured to solve a linear system of moments to obtain an optimal local polynomial approximation;
computer usable code configured to compute an error function based on said polynomial approximation; and
computer usable code configured to iteratively solve a linear system of moments and compute an error function until said error function is less than a predetermined threshold.
